(19) United States
(12) Patent Application Publication
(10) Pub. No.: US 2003/0138250 A1
(43) Pub. Date: Jul. 24, 2003

(54) Wavelength division multiplex (wdm) signal monitor

(76) Inventor: Gerard James Glynn, Towcester (GB)

Correspondence Address: Kirschstein Ottinger, Israel & SchiffMiller, 489 Fifth Avenue, New York, NY, 10017-6105, US

(21) Appl. No.: 10/239,942

(22) PCT Filed: Mar. 19, 2001
(86) PCT No.: PCT/GB01/01166

(30) Foreign Application Priority Data
Apr. 6, 2000 (GB) 0008483.0

(51) Int. Cl. H04B 10/08

(52) U.S. Cl. 398/34; 398/38

(57) ABSTRACT

A WDM signal monitor (4) for measuring optical power and/or wavelength of components of a WDM signal is disclosed. The monitor comprises: a wavelength selectable light source (20), preferably wavelength tuneable laser, which is operable to produce an optical output at known selectable wavelengths; an optical receiver (24) to which said optical output and WDM signal are applied and which is operable to produce an electrical signal whose frequency is representative of the difference in wavelength between a component of the WDM signal and optical output; means (22) for determining the power of the component of the WDM signal from the magnitude of said electrical signal; and means (22) for determining the wavelength of the component form the wavelength selected and the frequency of said electrical signal.

The present invention relates to a WDM signal monitor for measuring optical power and/or wavelength components of a WDM signal. More especially the invention concerns an optical signal monitor for measuring the optical power and/or wavelength of the constituent components, channels, of WDM, dense WDM (DWDM) and ultra dense WDM (UDWDM) optical communication signals.

The demand for ever higher communications capacity has led to the development of higher bandwidth optical communications systems. In an effort to utilise the available optical bandwidth more efficiently this has led to the development of Wavelength Division Multiplex (WDM) optical communications systems in which a plurality of independently modulated optical carriers are transmitted along a single optical fibre. The plurality of optical carriers is referred to as a WDM comb.

As technology has evolved so the number of carriers, often termed channels, has increased to presently as much as a hundred or more, with a data rate on each carrier of up to 10 GBs⁻¹. It is predicted that data rates will rise and may soon be as high as 40 GBs⁻¹ or greater. At the same time optical carrier separation has decreased from 1.6 nm (this corresponds to a frequency separation of 200 GHz) to 0.8 nm (100 GHz) and it is expected to further decrease to 0.4 nm (50 GHz). A WDM System with a 25 GHz carrier separation can be referred to as DWDM while systems with carrier separations of less than 25 GHz can be referred to as UDWDM.

As optical communication systems have evolved from simple point to point systems, to systems with optical amplifiers and to systems where particular wavelengths can be dropped or added at one or more remote nodes, so the need to precisely control the wavelength of each carrier has increased such as, for example, to prevent one data channel impairing the performance of another. Similarly, for various system reasons, it is desirable that the carrier amplitudes within a comb be maintained within a relatively narrow range. In optically amplified systems, amplified spontaneous emission (ASE) noise can degrade the optical signal to noise ratio, defined as the ratio of signal power to noise power at a certain wavelength offset from the signal. An increase in ASE may indicate that an amplifier is becoming faulty, and therefore, for system health monitoring, it is desirable to monitor the optical signal to noise ratio.

In an attempt to measure these various optical parameters, i.e. the power and wavelength of the constituent components of the WDM signal and optical signal to noise ratio, various approaches have been proposed. In all cases a small proportion of the optical signal from a selected point in the WDM system is tapped off and applied to an optical signal monitoring device. To reduce the number of power monitoring devices it is also known to switch optical signals from a number of different points from one system or points from different systems to one monitoring device. As a result, the monitoring device needs to be capable of operating over the total system wavelength and optical power ranges.

Typically telecommunications operators require fifteen year equipment lifetimes. For the optical signal monitor (OSM) this means that no calibration should be required for this period. One known OSM comprises a photodiode with a tuneable optical filter disposed in front such that an optical signal to be monitored passes through the filter to the photodiode.

The wavelength of light reaching the photodiode is known from the value of the tuneable filter's control parameter and the optical power of the optical signal at this wavelength can be determined from the photodiode's output current. A problem with such an OSM is obtaining an optical filter with sufficient selectivity so that it effectively rejects light from adjacent channels. To increase the selectivity of the filter it is known to arrange for the optical signal to make a double pass through the filter; that is the photodiode measures light which has been reflected rather than transmitted by the filter. However, with such an arrangement, light reflected from the filter's front facet can introduce error into the measurement.

OSMs are also known which comprise a diffraction grating or alternatively a Blazed Bragg grating combined with a linear photodiode array. The diffraction element is used to split the light such that different wavelengths are incident on different elements of the linear photodiode array. As a result each element detects the optical power for a given small wavelength band. With such an OSM the complete optical spectrum is detected simultaneously. Diffraction gratings however have an inherent polarisation sensitivity which is difficult to overcome. Furthermore such an OSM is prone to losing spectral information when the diffracted light falls between adjacent elements of the photodiode array.

In any monitoring system which uses a photodiode array the detected photocurrent may be of a similar magnitude to the uncooled photo detector's dark current. It is known to cool the array to keep the dark current low. However, cooling increases the electrical power consumption considerably. Alternatively it is known to periodically block the input light and to measure the dark current to allow a correction to be made. This can adversely affect the reliability of the optical monitoring device.

The wavelength range and resolution of known optical power monitoring devices is fixed when the device is manufactured, making future extension of their operation to DWDM and UDWDM systems difficult.

A need exists therefore for an optical power monitor of increased sensitivity, selectivity, wavelength range and operational flexibility.

The present invention has arisen in an endeavour to provide an optical power monitor for use with WDM, DWDM and UDWDM optical communications signals which at least in part overcomes the limitations of the known optical power monitors.

According to the present invention a WDM optical signal monitor for measuring optical power of components of a WDM signal comprises: a wavelength selectable light source which is operable to produce an optical output at a known selectable wavelength; an optical receiver to which said optical output and the WDM signal are applied and which is operable to produce an electrical signal whose frequency is representative of the difference in wavelength between a component of the WDM signal and optical output and; means for determining the power of the component of the WDM signal from the magnitude of said electrical signal.

According to a second aspect of the invention a WDM signal monitor for measuring wavelength of components of a WDM signal comprises: a wavelength selectable light source which is operable to produce an optical output at a known selectable wavelength; an optical receiver to which said optical output and the WDM signal are applied and which is operable to produce an electrical signal whose frequency is representative of the difference in wavelength between a component of the WDM signal and optical output; and means for determining the wavelength of the component of the WDM signal from the wavelength selected and the frequency of said electrical signal.

Alternatively according to a third aspect of the invention a WDM signal monitor for measuring wavelength of components of a WDM signal comprises: a wavelength selectable light source which is operable to produce an optical output at a known selectable wavelength; an optical receiver to which said optical output and WDM signal are applied and which is operable to produce an electrical signal whose frequency is representative of the difference in wavelength between a component of the WDM signal and optical output; and means for detecting the presence of the electrical signal within a selected bandwidth indicating that the wavelength of the component of the WDM signal substantially corresponds with the wavelength selected.

According to a fourth aspect of the invention a WDM signal monitor for measuring optical power and wavelength of components of a WDM signal comprises: a wavelength selectable light source which is operable to produce an optical output at a known selectable wavelength; an optical receiver to which said optical output and WDM signal are applied and which is operable to produce an electrical signal whose frequency is representative of the difference in wavelength between a component of the WDM signal and optical output; means for determining the power of the component of the WDM signal from the magnitude of said electrical signal; and means for determining the wavelength of the component from the wavelength selected and the frequency of said electrical signal.

Preferably the wavelength selectable light source comprises a wavelength tuneable laser. Advantageously the optical signal monitor further comprises wavelength measuring means for measuring the wavelength of the optical output produced by the laser and control means responsive to said wavelength measuring means for controlling the laser to maintain the optical output at the selected wavelength.

Preferably the optical signal monitor further comprises optical power monitoring means for measuring the optical power produced by the laser.

In a particularly preferred embodiment the optical receiver comprises a balanced optical to electrical converter. Advantageously the optical signal monitor further comprises a matched 3 dB optical combiner for respectively applying the optical output and WDM signals to respective inputs of the balanced optical to electrical converter.

Preferably the optical signal monitor further comprises a bandpass filter connected to the output of the optical receiver in which the passband of the filter is selected such as to allow passage of electrical signals which correspond with one of the components of the WDM signal.

For economy it is preferred to operate a plurality of WDM signal monitors using a single wavelength selectable light source.

A WDM signal monitor in accordance with the invention will now be described by way of example only with reference to the accompanying drawings in which:

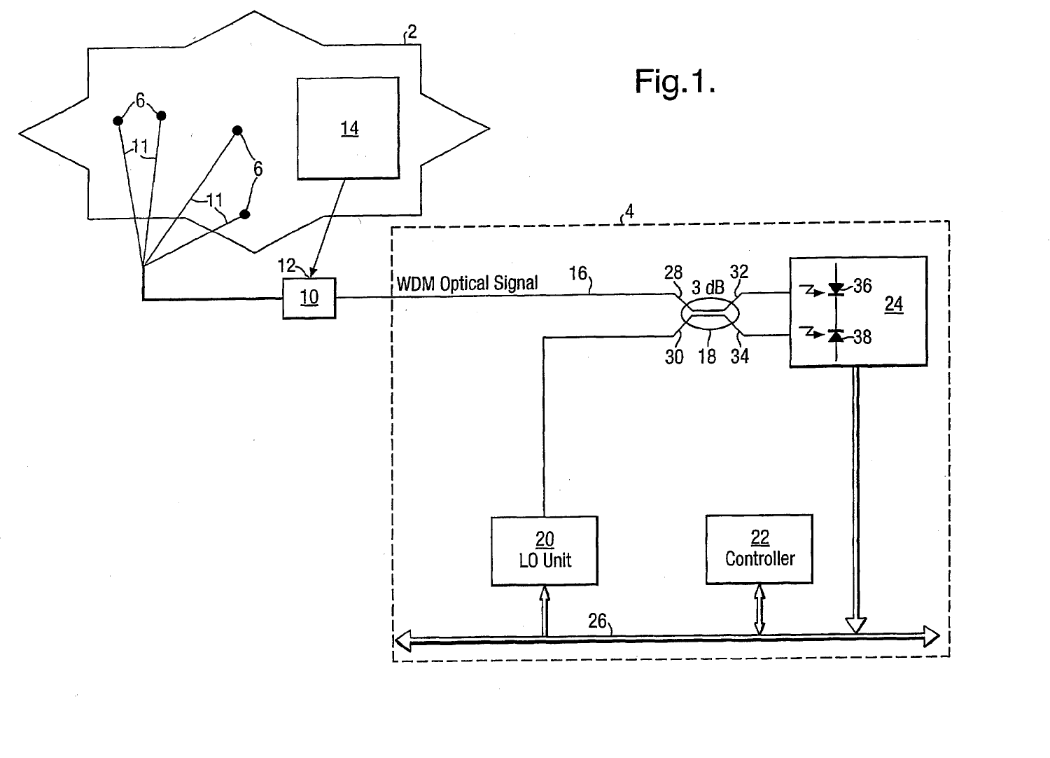

FIG. 1 is a schematic representation of a WDM signal monitor in accordance with the invention for measuring optical power and wavelength of the constituent components of a WDM optical communications signal;

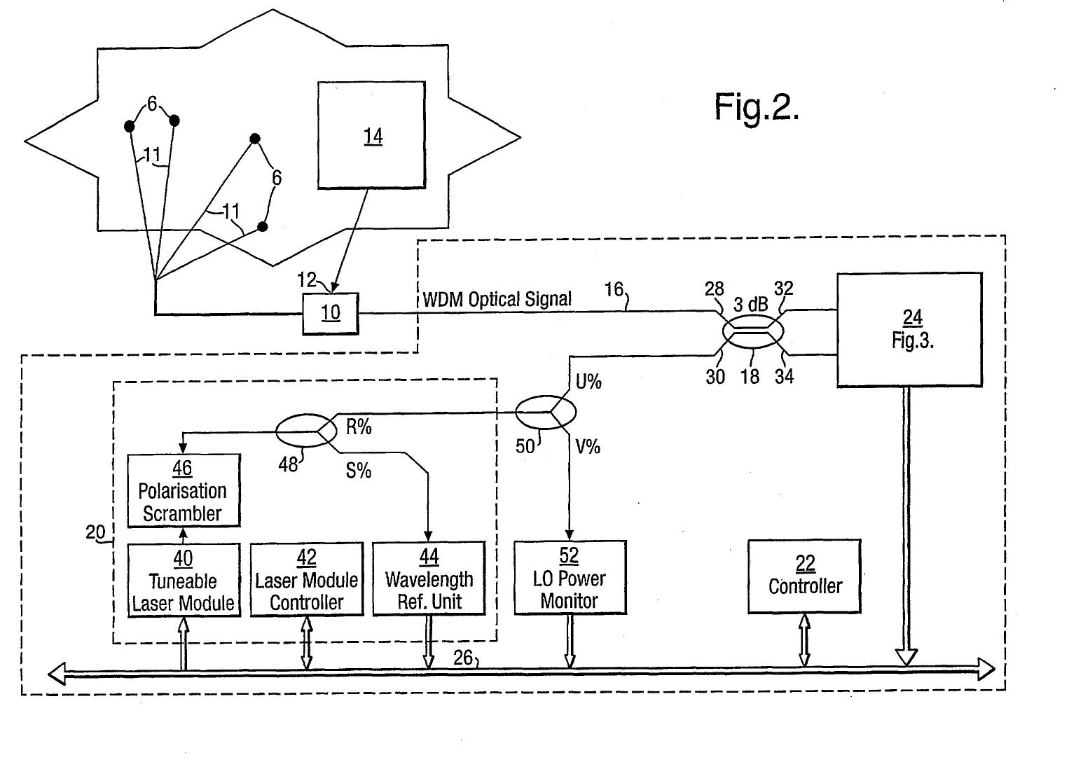

FIG. 2 is a schematic representation of a WDM signal monitor in accordance with a preferred embodiment of the invention; and

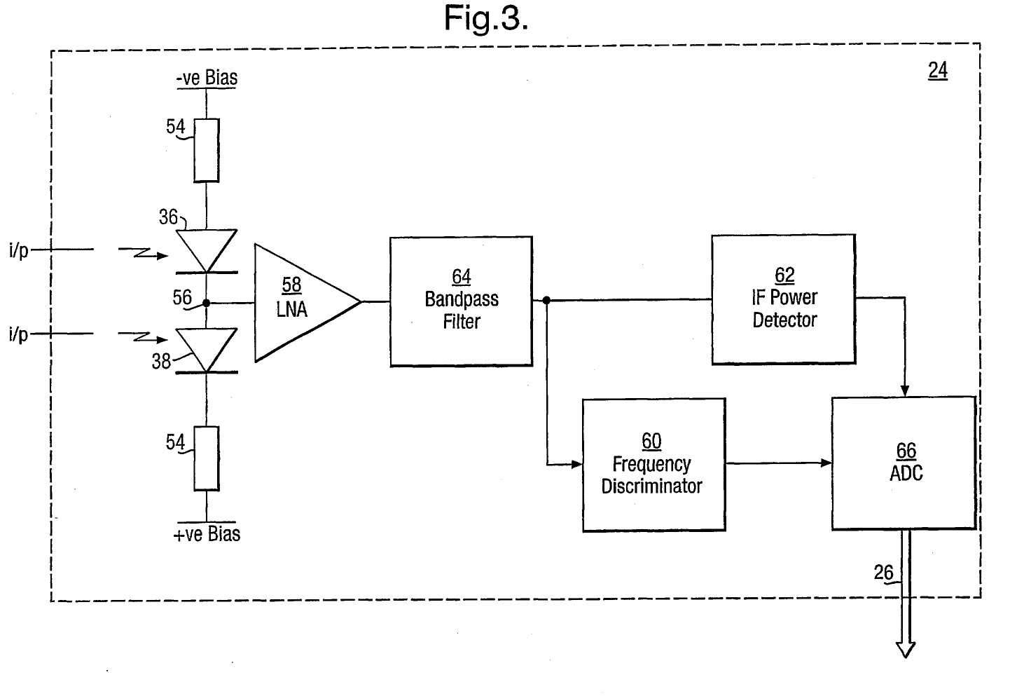

FIG. 3 is a representation of an optical-to-electrical converter, for the WDM signal monitor of FIG. 2.

Referring to FIG. 1 there is shown a WDM optical communication system 2 and an optical signal monitor (OSM) 4. The OSM 4 is operable to measure optical power, wavelength and optical signal to noise ratio for the constituent components of WDM optical communications signals. In the embodiment described the optical communication system 2 is a thirty two/forty channel DWDM system having a 100 GHz carrier spacing and a data rate of 2.5 GBs⁻¹/10 GBs⁻¹. It will be appreciated that the OSM of the invention is equally suited to other types of WDM systems such as a UDWDM system.

A plurality of monitoring points 6 are provided at selected locations within the WDM system 2 at which points a small proportion, typically 5%, of the WDM optical signal is tapped off from the system. The monitor points 6 are essentially non-intrusive tap points which do not significantly affect the operation of the WDM system 2. The WDM optical signals from the plurality of N monitor points 6 are brought together, in a spatially separated manner to an N:1 optical space switch 10. In the embodiment illustrated each monitor point 6 is connected to the space switch 10 by a respective singlemode optical fibre 11. The optical switch 10 is operable to select the WDM optical signal to be measured. Control of the optical switch 10 is provided via a control input 12 from a part of the WDM overall system management controller 14. The monitor points 6 can be at any point on the WDM system 2 such as, for example, at a transmitter, receiver, add/drop multiplexer, in-line amplifier etc. It will be appreciated therefore that the OSM 4 has a dynamic range large enough to cover all possible wavelength and optical power ranges on the WDM optical system 2.

A single mode optical fibre 16 is connected to the output of the optical switch 10 and provides the optical input to the OSM 4. The OSM 4 comprises a 3 dB optical splitter (combiner) 18, an optical local oscillator (LO) unit 20, a controller 22 and a balanced optical to electrical converter (receiver) 24. The LO unit 20, controller 22 and balanced converter 24 are each connected to a data bus 26 to facilitate communication therebetween. The data bus 26 is also accessible to the WDM overall management system 14 enabling communication with the controller 20 of information such as, for example, the tap ratio (that is the proportion of light tapped off) at the selected monitor point 6, which is required by the controller 22 to correctly determine the optical power.

The optical fibre 16 is coupled into a first input arm 28 of the optical combiner 18. The optical output of the LO unit 20 is coupled to a second input arm 30 of the combiner 18 and the two optical outputs 32, 34 of the combiner 18 are coupled to respective inputs of the balanced converter 24. The optical combiner 18 can be in the form of an optical fibre device or fabricated as a waveguide device in, for example, silicon or lithium niobate. As is known, a 3 dB optical splitter splits optical signals applied to a given input equally between its outputs and introduces a π/2 phase difference between them. Since in the present application the splitter acts to combine two optical signals applied to its inputs it will accordingly be referred to as an optical combiner.

In operation the WDM overall system management controller 14 selects a monitor point 6 using the space switch 10 and communicates to the controller 22 the tap ratio of the selected point. The LO unit 20 is operable to produce an optical output, local oscillator signal, whose wavelength is cyclically stepped through a series of selected wavelengths within the WDM signal window. Ideally the optical signal produced by the LO unit 22 is of a known constant intensity (power) for all selectable wavelengths. In practice the output power of the LO unit 20 may vary over time and may not be constant for all wavelengths. For this reason, as will be described below, the OSM 4 includes power monitoring means which are capable of communicating the power of the LO signal, via the data bus 26, to the controller 22. For the embodiment described the LO unit 20 is switched at 625 MHz steps.

The WDM optical signal and LO optical signal, appearing at the inputs 28, 30 of the combiner 18, are equally split such that half of each signal appears at the outputs 32, 34.

The two optical signals are applied to respective inputs of the balanced converter 24 which, as described below, essentially comprises two photodiodes 36, 38 which are connected in series. Each photodiode 36, 38 produces an electrical current whose magnitude is dependent on the intensity of the WDM optical signal and the LO optical signal. Since the photodiodes 36, 38 are connected in series currents from self homodyne processes are of equal magnitude but of opposite polarity and cancel, thereby rejecting any common mode signals applied to the inputs of the converter 24. Currents produced by in-band heterodyne processes vary from in-phase to antiphase and hence produce an intermediate frequency (IF). This IF frequency is representative of the difference between a wavelength of the WDM optical signal and of the LO. As the LO unit 20 is stepped through its range of selectable wavelengths the frequency and magnitude of the IF signals are measured. It will be appreciated that a number of IF signals will be generated corresponding to the wavelength difference between wavelengths of the WDM comb and a number of LO wavelengths. To limit the number of sample signals the receiver 24 has a limited bandwidth of 200 to 1400 MHz. With such a passband combined with a 625 MHz step size each signal wavelength is effectively four times oversampled. It will be appreciated that other passbands and step sizes can be used to avoid oversampling, if required.

The controller 22 determines the optical power and wavelength for each of the constituent components of the WDM optical signal as follows. For each LO wavelength the controller 22, by means of the data bus 26, interrogates the receiver 24 for the value of LO power, the IF frequency and power. Since the LO wavelength is known the controller 22 can accurately determine the wavelength of the detected carrier in the WDM optical signal using the measured IF frequency. The optical power of each of the carriers is determined by the controller 22 using the measured power of the IF signal and the LO power. The controller 22 increments the LO unit 20 to the next wavelength and the procedure of determining the optical powers and wavelengths is repeated. In this way the power and wavelength of all the optical signals within the WDM window can be measured. If desired the optical to signal to noise ratio can also be calculated using the optical power values and a measure of the background optical power. The OSM of the present invention is thus a form of scanning spectrometer. The controller 22 checks that the carrier wavelengths and optical powers are within preset system limits and communicates confirmation to this effect to the WDM overall system management system 14. In the event that a carrier wavelength or optical power is measured which is not within a preset limit the controller 22 alerts the WDM overall system management system 14 which can then take appropriate action.

Referring to FIGS. 2 and 3 there is shown an OPM 4 in accordance with a preferred implementation. In this embodiment, as shown in FIG. 2, the LO unit 20 comprises a tuneable laser module 40, a laser module controller 42, a wavelength reference unit 44, a polarisation scrambler 46 and a first optical splitter 48, 50. The laser module 40, module controller 42 and reference unit 44 are connected to the data bus 26. The laser module 40 contains a packaged wavelength tuneable laser and its associated current sources, both fixed and variable, and a temperature controller. In this embodiment a plurality of precision current sources are required to select the wavelength of light produced by the module 40. It will be appreciated that in other embodiments different types of tuneable light sources can be used which use different forms of wavelength selection techniques. The only requirement of the laser module 24, more particularly the LO unit 20, is that it generates light of selectable wavelengths which covers the wavelength range of WDM optical signals within the WDM window. The optical output produced by the laser module 40 is applied to the polarisation scrambler 46 to accommodate for the different signal states of polarisation (SOPs) which may exist in the incoming WDM wavelength comb. The polarisation scrambler 46 scrambles the laser's linearly polarised optical output at a high rate in comparison to the receiver's video bandwidth. Scrambling the polarisation of the LO allows the use of a simple balanced receiver 24.

Since the currently available tuneable laser modules 40 are not guaranteed to produce light of precisely the same wavelength for a given temperature over their operating lifetime, the wavelength reference unit 44 is provided. A small proportion, S %, of the light produced by the laser module 40 is tapped off by the optical splitter 48 and applied to the wavelength reference unit 44. The wavelength reference 44 can be based solely on stable fibre Bragg gratings or on a stable Bragg grating in conjunction with a Fabry Perot etalon or some other source of stable wavelengths. The function of the wavelength reference 44 is to measure the wavelength of light produced by the laser module 40 and convey this information, via the data bus 26, to the laser module controller 42.

The laser module controller 42 contains control lookup tables which it uses to continually step the laser module through its sequence of wavelengths. Each wavelength is set up and held for a set period of time and the laser module controller 42 indicates to the controller 22, with a time mark, that the wavelength has been set and its value. The laser module controller 42 interrogates the wavelength reference unit 44 to confirm the accuracy of the selected wavelength. if persistent wavelength errors are observed the laser module controller removes the laser module 40 from service.

As described the controller 22 needs to know the LO optical power in order to determine an absolute value of the optical power of the WDM optical signal. In the preferred embodiment of FIG. 2 a small proportion, V %, of the LO power is tapped off by the second optical splitter 50 at a point close to the receiver 24 and applied to a LO power monitor 52. The LO power monitor 52, which conveniently comprises a low cost, low frequency, high accuracy, directly coupled optical receiver with an analogue to digital converter (ADC), provides an accurate estimate to be made of the LO power. The LO power is measured a set time after reception of the LO controller time mark to ensure that the LO power is stable and that the detected power level has reached full magnitude.

Referring to FIG. 3, the optical to electrical converter 24 is shown in detail. As described the photodiode 36 and 38 are connected in series, that is the anode of one is connected to the cathode of the other. Both photodiodes are. reverse biased with the first photodiode 36 being biased with a negative voltage and the second photodiode 38 being biased with a positive voltage by an appropriate biasing network 54. The IF signal appearing at the interconnection 56 of the photodiodes is amplified by a low noise amplifier (LNA) 58 and the amplified IF signal is applied in parallel to an IF frequency discriminator 60 and IF power detector 62 via a bandpass filter 64. The IF frequency discriminator 60 is operable to measure the frequency of the IF signal whilst the IF power monitor 62 is operable to measure the power at the IF frequency. Both the discriminator 60 and detector 62 are connected to the data bus 26 by an analogue to digital converters (ADC) 66. If equal optical powers impinge on the photodiode 36, 38 and they have identical transducer efficiencies, equal currents are produced in their outputs. Since the photodiode 36 is biased by a negative voltage the electrical current generated is carried by negative charges which flow towards interconnection 56. Conversely the photodiode 38 is biased with a positive voltage the electrical current flowing towards interconnection 56 is carried by positive charges. Ideally for self homodyne processes these currents are equal in magnitude but opposite in sign and hence cancel at interconnection 56. The degree of cancellation is the common mode rejection of the optical receiver 24. For this cancellation to be efficient the differential delay between the optical combiner 18 and the respective photodiode 36, 38 must be small compared to the period that the IF electrical signals that are within the passband of the filter 64.

When the LO and a signal wavelength are in antiphase at the coupling region of the combiner 18 they will be in phase quadrature at each output and their products will be in antiphase. In this case, the differencing action of the photodiode 36, 38 produces a nonnegative output. Since in general the LO and WDM signal components will not be at the same frequency, the phase between the two will continuously cycle from in-phase to antiphase, producing nulls and peaks in their product, this is the IF signal. The benefit of self homodyne signal cancellation and an IF bandpass signal, is that this allows the receiver to operate at in-band (with respect to the WDM baseband data signals) IF frequencies.

The balanced receiver 24 effectively provides the filtering of the unwanted optical signals without the need for additional optical filtering and the bandpass filter rejects unwanted electrical out-of-band mixed components. The use of an in-band IF greatly eases the requirements on the electronics for the frequency discriminator 60 and the IF power detector 62, allowing for the use of commercially available components.

The LNA 58 can be a 50-ohm MMIC device. The IF frequency discriminator 60 conveniently comprises a simple amplified parallel lead-lag, lag-lead circuit, the ratio of the two sides gives a 1:1 frequency to output voltage relationship. This gives a sufficiently accurate measure of frequency to indicate where the IF signal is in the passband.

The bandpass filter 64 is conveniently realised by cascading a highpass and a lowpass filter to give a passband of 200-1400 MHz (bandwidth of 1.2 GHz). The IF power detector 62 is a high frequency, high dynamic range, detecting log amplifier with a low temperature coefficient.

It will be appreciated by the skilled person that the optical signal monitor described is an example of one possible implementation of the invention and that variations can be made which are within the scope of the invention. For example, whilst the monitor has been described as sequentially scanning through the wavelengths in order it is also envisaged to step the wavelength in a different order if desired or to stop the LO at a particular WDM carrier wavelength and to use the measured IF signal to track wavelength changes in the WDM carrier wavelength. Alternatively the latter could be used to detect supervisory tones or demodulate supervisory channels present on the WDM signal. Whilst in the embodiment described both optical power and wavelength is measured for each of the constituent components of the WDM signal it is envisaged in other implementations to have an OSM which measures only power or only wavelength. Furthermore whilst the OSM described accurately calculates the wavelength using the LO wavelength and the frequency of the IF signal it is also envisaged in an alternative embodiment to merely detect for the presence of an IF signal thereby indicating that the wavelength of the component of the WDM signal corresponds with the LO wavelength to within the bandwidth of the receiver.

The OSM of the present invention offers advantages over the known OSMs in that the absolute frequency range of operation is limited only by the tuneable laser's operating range and the optical receiver's spectral response. A particular advantage of the OPM of the present invention is that the resolution bandwidth, effectively the bandpass filter bandwidth, can readily be made narrower than an optical filter.

In yet a further embodiment it is envisaged to service a plurality of OSMs using a single LO unit to reduce the size and cost. In such an arrangement, it is envisaged that the polarisation scrambled LO output power could be split into a plurality of outputs, not necessarily all equal, with appropriate levels being used for different functions. This would have the effect of significantly decreasing the cost and size of the monitor, enabling a greater number to be used, which can be located locally at convenient locations within the WDM system 2.

The OSM of the present invention lends itself naturally to miniaturisation, and it is preferred to fabricate the photodiodes as InGaAs/InP matched quads, arranged in NIP/PIN pairs with the associated optical waveguide couplers and electrical amplifiers. The embedded controller 22 is preferably fabricated as a Field Programmable Array (FPGA).

Whilst the use of a balanced optical receiver is preferred because of its common mode noise rejection properties, other forms of receivers can be used to measure the IF signal.

The selection of the IF bandwidth is determined by the achievable setting and settling accuracy of the LO unit and the sample step size.

Whilst the optical power monitor of the present invention is primarily intended for measuring the optical power of the constituent components of a VDM optical signal, it will be appreciated that it can be applied to any application in which it is desired to measure optical power at a selected wavelength or over a selected wavelength band, or to measure wavelength only.

1. A WDM signal monitor (4) for measuring optical power of components of a WDM signal comprising: a wavelength selectable light source (20) which is operable to produce an optical output at a known selectable wavelength; an optical receiver (24) to which said optical output and WDM signal are applied and which is operable to produce an electrical signal whose frequency is representative of the difference in wavelength between a component of the WDM signal and optical output and; means (22) for determining the power of the component of the WDM signal from the magnitude of said electrical signal.

2. A WDM signal monitor (14) for measuring wavelength of components of a WDM signal comprising: a wavelength selectable light source (20) which is operable to produce an optical output at a known selectable wavelength; an optical receiver (24) to which said optical output and WDM signal are applied and which is operable to produce an electrical signal whose frequency is representative of the difference in wavelength between a component of the WDM signal and optical output; and means (22) for determining the wavelength of the component of the WDM signal from the wavelength selected and the frequency of said electrical signal.

3. A WDM signal monitor for measuring wavelength of components of a WDM signal comprising: a wavelength selectable light source (20) which is operable to produce an optical output at a known selectable wavelength; an optical receiver (24) to which said optical output and WDM signal are applied and which is operable to produce an electrical signal whose frequency is representative of the difference in wavelength between a component of the WDM signal and optical output; and means (22) for detecting the presence of the electrical signal within a selected bandwidth indicating that the wavelength of the component of the optical WDM substantially corresponds with the wavelength selected.

4. A WDM signal monitor (4) for measuring optical power and wavelength of components of a WDM signal comprising: a wavelength selectable light source (20) which is operable to produce an optical output at a known selectable wavelength; an optical receiver (24) to which said optical output and WDM signal are applied and which is operable to produce an electrical signal whose frequency is representative of the difference in wavelength between a component of the WDM signal and optical output; means (22) for determining the power of the component of the WDM signal from the magnitude of said electrical signal; and means (22) for determining the wavelength of the component from the wavelength selected and the frequency of said electrical signal.

5. A WDM signal monitor according to any preceding claim in which the wavelength selectable light source (20) comprises a wavelength tuneable laser (40).

6. A WDM signal monitor according to claim 5 and further comprising wavelength measuring means (44) for measuring the wavelength of the optical output produced by the laser (40) and control means (42) responsive to said wavelength measuring means (44) for controlling the laser (40) to maintain the optical output at the known wavelength.

7. A WDM signal monitor according to claim 6 and further comprising power monitoring means (52) for measuring the optical power produced by the laser (40).

8. A WDM signal monitor according to any preceding claim in which the optical receiver (24) comprises a balanced optical to electrical converter (36, 38).

9. A WDM signal monitor according to claim 8 and further comprising a matched 3 dB optical combiner (18) for respectively applying the optical output and WDM signals to respective inputs of the balanced optical to electrical converter (36, 38).

10. A WDM signal monitor according to any preceding claim and further comprising a bandpass filter (64) connected to the output of the optical receiver in which the passband of the filter (64) is selected such as to allow passage of electrical signals which correspond with one of the components of the WDM signal.

11. A plurality of WDM signal monitors according to any preceding claim which are operable with a single wavelength selectable light source.

12. A WDM signal monitor for measuring optical power and/or wavelength of components of a WDM signal substantially as hereinbefore described with reference to or substantially as illustrated in the accompanying drawings.
